(19) United States
(12) Patent Application Publication
(10) Pub. No.: US 2026/0019113 A1
(43) Pub. Date: Jan. 15, 2026

(54) Approaches for MIMO Transmission

(71) Applicant: Telefonaktiebolaget LM Ericsson (publ), Stockholm (SE)

(72) Inventors: Xueying Hou, Lund (SE); Mats Åhlander, Solna (SE)

(21) Appl. No.: 18/875,483

(22) PCT Filed: Jul. 7, 2022
(86) PCT No.: PCT/EP2022/068959

§ 371 Date: Dec. 16, 2024

(51) Int. Cl. H04B 7/0426; H04B 17/309; H04W 72/23

(52) U.S. Cl. CPC H04B 7/043; H04B 17/346; H04W 72/23

(57) ABSTRACT

A method for a radio access node is disclosed. The method is for communicating with a plurality of users by multiple-input multiple-output (MIMO) transmission. The radio access node is configured to receive user feedback indicative of downlink channel estimates, and to use uplink channel estimates for uplink channel estimate based beamforming of the MIMO transmission. The method comprises determining a beamforming gain increment achievable by using the downlink channel estimates for beamforming of the MIMO transmission, adjusting (based on the beamforming gain increment) a signal-to-interference ratio (SIR) value and/or a signal-to-interference-and-noise ratio (SINR) value associated with the user feedback, and performing or causing downlink (DL) MIMO transmission to one or more user of the plurality of users based on the adjusted SIR value and/or SINR value. For example, DL MIMO transmission may comprise using the adjusted SIR value and/or SINR value for one or more of: link adaptation, MIMO rank selection, and multi-user (MU) grouping. Corresponding computer program product apparatus, radio access node, server node, and distributed MIMO control node are also disclosed.

### TECHNICAL FIELD

The present disclosure relates generally to the field of wireless communication. More particularly, it relates to approaches for multiple-input multiple-output (MIMO) transmission.

### BACKGROUND

A general problem in relation to wireless communication is how to achieve as high throughput as possible under given channel conditions. This problem is also applicable for multiple-input multiple-output (MIMO) transmission.

Although various approaches exist that aim for increased throughput, there are communication scenarios where the capacity of the given channel conditions is not fully exploited.

Generally, a communication scenario may be defined by channel conditions and/or by which devices are involved in the communication.

Therefore, there is a need for alternative approaches to MIMO transmission. Preferably, such approaches should—in one or more communication scenarios—provide increased throughput compared to one or more other approaches.

### SUMMARY

It should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Generally, when an arrangement is referred to herein, it is to be understood as a physical product; e.g., an apparatus. The physical product may comprise one or more parts, such as controlling circuitry in the form of one or more controllers, one or more processors, or the like. It is an object of some embodiments to solve or mitigate, alleviate, or eliminate at least some of the above or other disadvantages.

A first aspect is a method for a radio access node. The method is for communicating with a plurality of users by multiple-input multiple-output (MIMO) transmission. The radio access node is configured to receive user feedback indicative of downlink channel estimates. The radio access node is also configured to use uplink channel estimates for uplink channel estimate based beamforming of the MIMO transmission.

The method comprises determining a beamforming gain increment achievable by using the downlink channel estimates for beamforming of the MIMO transmission, adjusting (based on the beamforming gain increment) a signal-to-interference ratio (SIR) value and/or a signal-to-interference-and-noise ratio (SINR) value associated with the user feedback, and performing or causing downlink (DL) MIMO transmission to one or more user of the plurality of users based on the adjusted SIR value and/or SINR value.

In some embodiments, the DL MIMO transmission is a single-user (SU) MIMO transmission.

In some embodiments, the DL MIMO transmission is a multi-user (MU) MIMO transmission.

In some embodiments, the DL MIMO transmission comprises dynamic MU grouping over time.

In some embodiments, DL MIMO transmission comprises using the adjusted SIR value and/or SINR value for the MU grouping.

In some embodiments, the downlink channel estimates are associated with MU grouping used at a previous transmission occasion.

In some embodiments, the beamforming gain increment is determined for each of a collection of MU grouping hypotheses.

In some embodiments, DL MIMO transmission comprises using the adjusted SIR value and/or SINR value for controlling MIMO configuration of an upcoming transmission occasion.

In some embodiments, DL MIMO transmission comprises using the adjusted SIR value and/or SINR value for link adaptation and/or MIMO rank selection.

In some embodiments, using the adjusted SIR value and/or SINR value for MIMO rank selection comprises calculating (for each of a plurality of hypothesized ranks) a respective amount of information carried per sub-carrier based on the adjusted SIR value and/or SINR value, and performing rank selection among the plurality of hypothesized ranks based on the respective amount of information carried per sub-carrier.

In some embodiments, performing rank selection comprises selecting the hypothesized rank which has the highest respective amount of information carried per sub-carrier among the plurality of hypothesized ranks.

In some embodiments, using the adjusted SIR value and/or SINR value for link adaptation comprises selecting a modulation and coding scheme (MCS) that is associated with the adjusted SIR value and/or SINR value.

In some embodiments, the beamforming gain increment comprises a plurality of respective beamforming gain increments, each respective beamforming gain increment corresponding to a hypothesized number of MIMO layers.

In some embodiments, the beamforming gain increment is determined based on a discrepancy between determinants of a first channel representation and a second channel representation, wherein the first channel representation corresponds to application of the uplink channel estimate based beamforming and the second channel representation corresponds to application of user feedback based beamforming.

In some embodiments, the beamforming gain increment is determined based on a discrepancy between a first signal power and a second signal power, wherein the first signal power corresponds to beamforming power for application of the uplink channel estimate based beamforming and the second signal power corresponds to beamforming power for application of user feedback based beamforming.

In some embodiments, the discrepancy between the first signal and second signal powers is only considered for adjustment of the SIR value and/or SINR value when the first signal power is larger than the second signal power.

In some embodiments, the discrepancy between the first signal and second signal powers is compensated based on a difference between a number of MIMO layers associated with the user feedback and the hypothesized number of MIMO layers.

In some embodiments, the discrepancy between the first signal and second signal powers is compensated based on an inter-layer interference.

In some embodiments, the first and second signal powers are determined by scaling of respective channel estimates.

In some embodiments, the beamforming gain increment is determined per user.

In some embodiments, the user feedback comprises one or more of: channel quality information (CQI), precoding matrix index (PMI), and rank indicator (RI).

In some embodiments, the uplink channel estimate based beamforming is a reciprocity based beamforming.

In some embodiments, the uplink channel estimate based beamforming is determined by the radio access node based on one or more user transmission of at least one type of uplink signal.

In some embodiments, the at least one type of uplink signal comprises sounding reference signal (SRS).

A second aspect is a computer program product comprising a non-transitory computer readable medium, having thereon a computer program comprising program instructions. The computer program is loadable into a data processing unit and configured to cause execution of the method according to the first aspect when the computer program is run by the data processing unit.

A third aspect is an apparatus for a radio access node configured for communication with a plurality of users by multiple-input multiple-output (MIMO) transmission, wherein the radio access node is configured to receive user feedback indicative of downlink channel estimates, and wherein the radio access node is configured to use uplink channel estimates for uplink channel estimate based beamforming of the MIMO transmission.

The apparatus comprises controlling circuitry configured to cause determination of a beamforming gain increment achievable by use of the downlink channel estimates for beamforming of the MIMO transmission, adjustment (based on the beamforming gain increment) of a signal-to-interference ratio (SIR) value and/or a signal-to-interference-and-noise ratio (SINR) value associated with the user feedback, and downlink (DL) MIMO transmission to one or more user of the plurality of users based on the adjusted SIR value and/or SINR value.

A fourth aspect is a radio access node comprising the apparatus of the third aspect.

A fifth aspect is a server node comprising the apparatus of the third aspect, wherein the server node is configured to control the radio access node.

A sixth aspect is a control node comprising the apparatus of the third aspect, wherein the control node is configured to control a plurality of access points of a distributed MIMO system, and wherein the radio access node is one of the access points.

In some embodiments, any of the above aspects may additionally have features identical with or corresponding to any of the various features as explained above for any of the other aspects.

An advantage of some embodiments is that alternative approaches to MIMO transmission are provided.

An advantage of some embodiments is that increased throughput is provided compared to other approaches.

An advantage of some embodiments is that improved rank selection is provided compared to other approaches (e.g., selection of a number of MIMO layers that is more appropriate for the communication scenario at hand).

An advantage of some embodiments is that improved link adaptation is provided compared to other approaches (e.g., selection of a modulation and coding scheme, MCS, that is more appropriate for the communication scenario at hand).

An advantage of some embodiments is that improved multi-user (MU) grouping is provided compared to other approaches (e.g., selection of a group of users for MU transmission that is more appropriate for the communication scenario at hand).

Generally, being more appropriate for a communication scenario may be defined as achieving higher throughput in the communication scenario.

Also generally, throughput may refer to throughput for an individual user and/or to accumulated throughput for two or more users.

It should be noted that, even though described in the context of terminology from Third Generation Partnership (3GPP) standardization, embodiments may be equally applicable for other types of communication (e.g., communication according to IEEE802.11 standardization).

### BRIEF DESCRIPTION OF THE DRAWINGS

Further objects, features and advantages will appear from the following detailed description of embodiments, with reference being made to the accompanying drawings. The drawings are not necessarily to scale, emphasis instead being placed upon illustrating the example embodiments.

FIG. 1 is a flowchart illustrating example method steps according to some embodiments;

FIG. 2 is a schematic block diagram illustrating example functions according to some embodiments;

FIG. 3 is a schematic block diagram illustrating an example apparatus according to some embodiments;

FIGS. 4A-C are schematic drawings illustrating example communication scenarios according to some embodiments;

FIG. 5 is a schematic drawing illustrating an example computer readable medium according to some embodiments;

FIG. 6 schematically illustrates a telecommunication network connected via an intermediate network to a host computer;

FIG. 7 is a generalized block diagram of a host computer communicating via a base station with a user equipment over a partially wireless connection; and

FIGS. 8 and 9 are flowcharts illustrating methods implemented in a communication system including a host computer, a base station and a user equipment.

### DETAILED DESCRIPTION

As already mentioned above, it should be emphasized that the term “comprises/comprising” (replaceable by “includes/including”) when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

In the following, various approaches to MIMO transmission will be disclosed and exemplified. At least some of the approaches provide increased throughput in one or more communication scenarios; compared to other approaches.

Generally, the term “user” is meant to encompass a user equipment (UE), as well as any other suitable wireless communication device (e.g., a station—STA—compliant with an IEEE802.11 standard, an Internet-of-Things—IoT—device, etc.), and the term “radio access node” is meant to encompass a base station (BS; e.g., a gNB), as well as any other suitable wireless communication node (e.g., an access point—AP—compliant with an IEEE802.11 standard, etc.). In the following description, a user is often exemplified with a UE and a radio access node is often exemplified by a gNB. These exemplifications are not to be construed as limiting.

Also generally, the term “channel” may refer to the transfer conditions only (i.e., conditions between transmitter antenna(s) and reception antenna(s)), or may also include the impact of one or more components of the transmitter and/or the impact of one or more components of the receiver.

MIMO communication in a wireless communication network is a technique wherein spatial diversity is exploited for using the same time and frequency resource to serve several users simultaneously, or to serve one user with multiple information streams. This is also referred to as spatial multiplexing. When MIMO is applied between a gNB and a UE, the gNB and/or the UE are equipped with multiple antennas. Spatial diversity typically enables more efficient utilization of the frequency spectrum compared to other communication techniques. Moreover, MIMO can reduce inter-cell interference and/or intra-cell interference, which may improve the possibilities for frequency re-use.

In spatial multiplexing, two or more data streams (MIMO layers) are transmitted over respective (ideally independent) channels that are spatially separated in space. The throughput increases when the number of simultaneously transmitted parallel MIMO layers increases.

Spatial channel separation may be efficiently utilized (e.g., to provide high throughput) via transmission and/or reception beamforming. DL transmission beamforming is a technique where a weighted coherent phase shift is added to each base station antenna element with the effect of creating a concentrated beam of energy from the base station antenna array towards a UE. The phase shifts are often collectively referred to as a pre-coder. There are various approaches for beamforming. For example, a Minimum Mean Square Estimator (MMSE) criterion or a Singular Value Decomposition (SVD) criterion may be used for computation of beam weights. Efficient utilization of spatial channel separation (e.g., to provide high throughput) is typically also related to how well the number of MIMO layers are matched to the rank of the channel and/or to how well link adaptation (e.g., selection of modulation and coding scheme—MCS) is performed for the channel. If the selected number of MIMO layers and MCS are not well suited for the selected pre-coder, the throughput will typically not reach the full potential of the channel. For example, when the selected pre-coder can support four MIMO layers with the highest MCS index, while the gNB transmits only three MIMO layers and/or uses a lower MCS index, the throughput will be restricted by the conservative selection of the gNB.

Thus, to properly configure MIMO communication (e.g., beamforming, selection of number of MIMO layers, link adaptation, etc.), it is beneficial to have information regarding the channel responses between the gNB and the users (e.g., in the form of downlink—DL—channel estimates). Such information is often called channel state information (CSI), and that exemplifying term will be used herein without limiting purposes. Information regarding these channel responses is useful for beamforming transmissions from the gNB towards the intended UE(s).

Generally, the UE(s) may be configured to perform measurements on reference signals (e.g., CSI reference signal—CSI-RS) transmitted by the gNB to determine DL channel estimates, and send user feedback (e.g., in the form of CSI reports) indicating the DL channel estimates to the gNB.

Also generally, the gNB may be configured to perform measurements on reference signals (e.g., sounding reference signal—SRS) transmitted by the UE(s) to determine uplink (UL) channel estimates.

In some situations, UL channel estimates are used by the gNB for DL beamforming. For example, it may be assumed that the DL channel is so similar to the reverse UL channel (possibly except for a power scaling factor) that beamforming based on the UL channel estimates can be applied for DL transmission instead of beamforming based on the DL channel estimates. This may be referred to as reciprocity based beamforming. One example, where reciprocity based beamforming may be applied is in time division duplex (TDD) systems. Alternatively, the DL beamforming may be based on transforming one or more UL channel estimates into a representation of the DL channel (e.g., by using approaches described in “Deep UL2DL: Data-Driven Channel Knowledge Transfer From Uplink to Downlink”, by M. S. Safari, V. Pourahmadi, and S. Sodagari, in IEEE Open Journal of Vehicular Technology, vol. 1, pp. 29-44, 2020, DOI: 10.1109/OJVT.2019.2962631). Then, the beamforming matrix can be derived based on the DL channel obtained from the UL channel estimates.

It should be noted that, even though problems and solutions are exemplified herein in the context where uplink channel estimates are used for reciprocity based beamforming, embodiments are equally applicable in the context of any uplink channel estimate based beamforming.

In some typical wireless communication systems (e.g., fifth generation new radio—5G NR), the gNB is configured to receive user feedback from UE(s) (e.g., in the form of CSI reports; typically including channel quality information—CQI, precoding matrix index—PMI, and rank indicator—RI). The gNB is typically configured to use the user feedback for part of the configuration of downlink transmission (e.g., use the CQI for MCS selection, and/or use the RI for selection of number of MIMO layers).

However, when the user feedback from UE(s) is based on an assumption of codebook based transmission, while the gNB applies reciprocity based beamforming (i.e., not codebook based beamforming), the downlink transmission configuration (e.g., MCS, and/or number of MIMO layers) will typically not be optimal for the beamforming that the gNB applies. One solution to address such mismatches between downlink transmission configuration based on user feedback and reciprocity based beamforming is outer-loop adjustment (OLA; also referred to outer-loop link adaptation—OLLA) at the gNB. OLA approaches are well known and will not be elaborated on further herein. Some problems with OLA approaches is that they converge relatively slowly, that they are typically unable to follow rapidly varying channel conditions, and that they are unsuitable for scenarios with sporadic traffic.

Thus, it is a problem with reciprocity based beamforming that, when the DL channel (at the time of transmission) is not exactly equal to the UL channel (at the time of measurement), the reciprocity based beamforming may be less than optimal. Furthermore, it is a problem that MCS selection and/or selection of number of MIMO layers does not match the applied beamforming when they are based on an assumption of codebook based transmission, while the gNB applies reciprocity based beamforming.

One way to properly selecting MCS and number of MIMO layers, is if the gNB would have access to information regarding the selected pre-coder to be applied, the DL channel at the time of transmission, the interference plus noise (IpN) as experienced by the UE, and particulars about the UE receiver (e.g., spatial de-multiplexing, equalization, channel estimation, etc.). In practice, however, the gNB may lack at least the information regarding the IpN as experienced by the UE, and/or particulars about the UE receiver. Furthermore, estimations by the gNB regarding the IpN as experienced by the UE may be inaccurate and/or may require computational complexity if the gNB. Therefore, it is desirable to provide other approaches that enable proper selection of MCS and number of MIMO layers.

Some embodiments address these and/or other problems by providing approaches in which the gNB (or another node) predicts the DL signal-to-interference ration (SIR) or SINR, which may then be used, for example, for selection of MCS and/or number of MIMO layers. Thereby, the benefits of beamforming applied at gNB can be exploited without estimation of the IpN as experienced by the UE. Compared to approaches that relies on estimation of the IpN as experienced by the UE, the suggested approaches may reduce the computational complexity in the gNB, and/or may reduce error propagation when the estimation of the IpN as experienced by the UE is not accurate. Compared to approaches that relies on direct use of user feedback, the suggested approaches may provide improved selection of MCS and/or number of MIMO layers, which can more fully exploit the benefits of the gNB beamforming. Compared to approaches that relies on direct use of user feedback together with OLA, the suggested approaches may provide faster convergence, and/or ability to follow rapidly varying channel conditions, and/or suitability for scenarios with sporadic traffic.

The suggested approaches will be exemplified by two classes of beamforming gain increments for adjustment of SIR and/or SINR as based on user feedback. One class is based on a ratio between the signal power of the beamforming applied at the gNB, and the signal power of a beamforming based on user feedback (e.g., a PMI based beamforming). Another class is based on a ratio between the equivalent channel matrix determinant for the beamforming applied at the gNB and, the equivalent channel matrix determinant for a beamforming based on user feedback (e.g., a PMI based beamforming). The determinant based class typically provides better performance (e.g., higher throughput) than the signal power based class, but has higher computational complexity than the signal power based class.

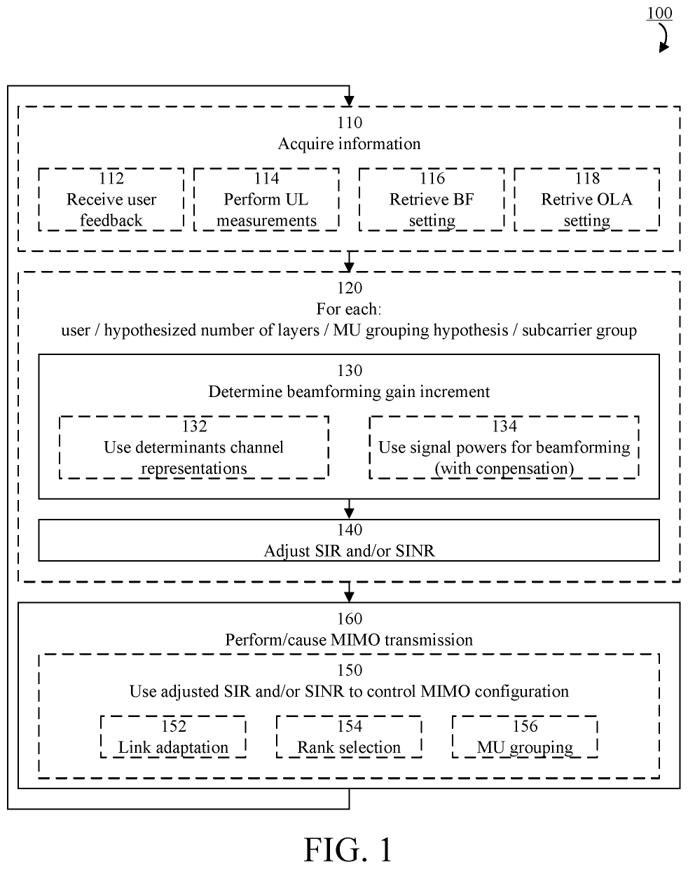

FIG. 1 illustrates an example method 100 according to some embodiments. The method 100 is for a radio access node communicating with a plurality of users by multiple-input multiple-output (MIMO) transmission.

The method 100 may be performed by the radio access node. Alternatively or additionally, the method 100 may be performed by a server node (e.g., a central network node or a cloud server) controlling the radio access node. Yet alternatively or additionally, the method 100 may be performed by a control node configured to control a plurality of access points of a distributed MIMO system.

The method 100 may be performed by a single node (e.g., a radio access node). Alternatively, the method 100 may be distributedly performed; i.e., two or more nodes (e.g., cloud computing nodes) each performing one or more steps, or part of a step, or the method 100.

In any case, the radio access node is configured to receive user feedback indicative of downlink channel estimates. For example, the user feedback may be in the form of channel state information (CSI) reports, and/or the downlink channel estimates may be based on user measurements on channel state information reference signals (CSI-RS) transmitted by the radio access node. In some embodiments, the user feedback comprises one or more of: channel quality information (CQI), precoding matrix index (PMI), and rank indicator (RI).

The radio access node is also configured to use uplink channel estimates for (e.g., reciprocity based) beamforming of the MIMO transmission. For example, the uplink channel estimates may be based on radio access node measurements on uplink signals transmitted by the user(s).

One example of such uplink signal is sounding reference signals (SRS) transmitted by the user(s). The SRS is an uplink only signal. Generally, the SRS is transmitted by the user(s) to help the gNB obtain channel state information for each user.

Other uplink signals and/or uplink reference signals may—alternatively or additionally—be used to obtain uplink channel estimates. For example, when a user is scheduled for uplink data transmission, the Demodulation Reference Signal (DMRS) can be used to obtain uplink channel estimates.

The uplink channel estimate based (e.g., reciprocity based) beamforming may be determined by the radio access node (or by another suitable node, such as a server node; e.g., a central network node or a cloud server) based on the uplink channel estimates.

As illustrated by optional step 110, the method may comprise acquiring information. In some embodiments, part/all of this information is already available when/where the method 100 is performed. For example, step 110 may comprise acquiring user feedback (e.g., receiving a CSI report), as illustrated by sub-step 112. Alternatively or additionally, step 110 may comprise performing—or otherwise acquiring—UL measurements (e.g., SRS measurements), as illustrated by sub-step 114. Yet alternatively or additionally, step 110 may comprise retrieving the beamforming (BF) setting, as illustrated by sub-step 116. The BF setting may comprise the BF setting used when the DL measurements were made and/or the BF setting that will be used for the upcoming MIMO transmission. Yet alternatively or additionally, step 110 may comprise retrieving the current OLA setting, as illustrated by sub-step 118.

In step 130, a beamforming gain increment is determined, which is achievable by using the downlink channel estimates for beamforming of the MIMO transmission. Thus, step 130 may be seen as determining a potential beamforming gain increment if the downlink channel estimates were used for beamforming instead of the uplink channel estimates.

In step 140, an SIR value and/or an SINR value associated with the user feedback is adjusted based on the beamforming gain increment. Thus, step 140 may be seen as adapting a SIR/SINR value which is based on the user feedback (i.e., which relates to the downlink channel estimates) such that it corresponds more closely to the actually applied uplink channel estimate based (e.g., reciprocity based) beamforming.

In step 160, downlink (DL) MIMO transmission to one or more user of the plurality of users is performed (e.g., when the method 100 is performed by a radio access node) or caused (e.g., when the method 100 is performed by a server node or a control node). The DL MIMO transmission is based on the adjusted SIR value and/or SINR value. The DL MIMO transmission may be a single-user (SU) MIMO transmission or a multi-user (MU) MIMO transmission.

In some embodiments, DL MIMO transmission may comprise using the adjusted SIR value and/or SINR value for controlling the MIMO configuration of an upcoming transmission occasion, as illustrated by optional sub-step 150. For example, the adjusted SIR value and/or SINR value may be used for link adaptation, as illustrated by 152. Alternatively or additionally, the adjusted SIR value and/or SINR value may be used for MIMO rank selection (i.e., selection of number of MIMO layers), as illustrated by 154. Yet alternatively or additionally, the adjusted SIR value and/or SINR value may be used for MU grouping, as illustrated by 156.

The latter may be particularly beneficial when the DL MIMO transmission comprises dynamic MU grouping over time. Then, the user feedback is related to the MU grouping at the time of measurements of the downlink channel (i.e., the downlink channel estimates are associated with MU grouping used at a previous transmission occasion), which MU grouping may be different that the one to be applied for the upcoming MIMO transmission.

Therefore, it may be beneficial to hypothesize two or more different MU groupings to be applied for the upcoming MIMO transmission (a collection of MU grouping hypotheses), determine the beamforming gain increment for each MU grouping hypothesis, and select which MU grouping to apply based on the correspondingly adjusted SIR/SINR values for each MU grouping hypothesis. For example, the MU grouping may be selected which yields the highest throughput among the MU grouping hypotheses of the collection, or a MU grouping may be selected which yields a throughput above a threshold value.

When the adjusted SIR value and/or SINR value is used for link adaptation, the link adaptation may comprise selecting a modulation and coding scheme (MCS) that is associated with the adjusted SIR value and/or SINR value. For example, any suitable mapping from SIR/SINR to MCS may be applied.

When the adjusted SIR value and/or SINR value is used for MIMO rank selection, the MIMO rank selection may comprise calculating (for each of a plurality of hypothesized ranks; i.e., for each of a plurality of hypothesized numbers of layers) a respective amount of information carried per sub-carrier based on the adjusted SIR value and/or SINR value. Then, the rank selection may be performed among the plurality of hypothesized ranks, based on the respective amount of information carried per sub-carrier. For example, the rank may be selected which has the highest respective amount of information carried per sub-carrier among the plurality of hypothesized ranks, or a rank may be selected which has a respective amount of information carried per sub-carrier above a threshold value. It should be noted that the amount of information carried per sub-carrier may be seen as an expression of throughput.

Thus, the beamforming gain increment may comprise a plurality of respective beamforming gain increments, each corresponding to a hypothesized number of MIMO layers (i.e., a hypothesized rank), and correspondingly adjusted SIR/SINR values may be used for selection of the number of MIMO layers.

Generally, as illustrated by optional block 120, steps 130 and 140 may be performed for each user and/or for each of a hypothesized number of layers and/or for each MU grouping hypothesis and/or for each sub-carrier group. Then, the control of the MIMO configuration in 150 may comprise maximizing the throughput (or achieving a throughput which is above a threshold value) by selection and/or combination based on the correspondingly adjusted SIR/SINR values. Control based on hypothesized number of layers and control based on MU grouping hypothesis have been exemplified above. Alternatively or additionally, a user may be selected user which has potential for the highest throughput, or which has potential for throughput above a threshold value.

The determination of step 130 may be exemplified by two different classes of beamforming gain increments.

According to one class of beamforming gain increments, the beamforming gain increment is determined based on a discrepancy between determinants of a first channel representation and a second channel representation, as illustrated by 132. The first channel representation corresponds to application of the uplink channel estimate based (e.g., reciprocity based) beamforming and the second channel representation corresponds to application of user feedback based beamforming.

According to another class of beamforming gain increments, the beamforming gain increment is determined based on a discrepancy between a first signal power and a second signal power, as illustrated by 134. The first signal power corresponds to beamforming power for application of the uplink channel estimate based (e.g., reciprocity based) beamforming and the second signal power corresponds to beamforming power for application of user feedback based beamforming. For example, the first and second signal powers may be determined by scaling of respective channel estimates.

In some embodiments, the discrepancy of the signal power based class is compensated for one or more modelling assumptions. For example, the discrepancy of the signal power based class may be compensated based on a difference between a number of MIMO layers associated with the user feedback and the hypothesized number of MIMO layers. Alternatively or additionally, the discrepancy of the signal power based class may be compensated based on an inter-layer interference (e.g., when the first and second signal powers are determined under an assumption that users cancel only a strongest inter-layer interference component).

In some embodiments, the discrepancy of the signal power based class is only considered for adjustment of the SIR value and/or SINR value when the first signal power is larger than the second signal power.

Generally, it should be noted that any embodiment may be combined with other techniques for MIMO transmission control, as suitable. For example, OLA may be applied for embodiments without link adaptation based on adjusted SIR/SINR, and/or may be applied in combination with link adaptation based on adjusted SIR/SINR.

Some various ways to implement various embodiments will now be presented through an example wherein a process corresponding to steps 130 and 140 is referred to as a gNB CSI estimation function, outputting per sub-carrier group (per-SCG) SINR for rank selection and link adaptation. Unless otherwise stated, the values of the SINR and the beamforming gain increments are expressed in decibel (dB).

The gNB CSI estimation function uses CSI feedback from UE (user feedback), gNB channel estimation based on SRS (uplink channel estimation; UL measurements), gNB pre-coder for beamforming (e.g., reciprocity based beamforming; BF setting), and outer loop adjustment (OLA setting) as input information—compare with step 110 of FIG. 1; referred to as step 0 below.

Based on this input information, the beamforming gain increment is determined for the beamforming solution applied by gNB (e.g., reciprocity based beamforming) compared with a pre-coder based on the PMI of the feedback from UE (using the downlink channel estimates for beamforming)—compare with step 130 of FIG. 1; referred to as step 1 below.

Then, the beamforming gain increment is added to the SINR derived from CSI feedback from UE (adjusting SINR associated with user feedback)—compare with step 140 of FIG. 1; referred to as step 2 below.

The resulting per-SCG SINR is used for both link adaptation and rank selection—compare with step 150 of FIG. 1; referred to as step 3 below.

Step 0 (Information Collection) The gNB CSI estimation function uses the following information as input for adjustment of SINR based on beamforming gain increment, wherein the adjusted SINR suitable for rank selection and MCS selection:
1) CSI feedback from UE (including CQI, PMI, and RI), wherein:

$${RI}_{u}^{fb}$$

denotes RI of the feedback from UE with index u,

$${W}_{u , k}^{PMI} ∈ ℂ ( {N}_{t} , {RI}_{u}^{fb} )$$

denotes the pre-coder based on PMI of the feedback from UE with index u, at sub-carrier group (SCG) index k, wherein Nₜ denotes the number of antennas of the gNB, and
CQI denotes CQI index of the feedback from UE with index u, wherein the CQI index can indicate wideband CQI or sub-band CQI (e.g., in accordance with 3GPP standardization).
2) gNB channel estimation based on SRS, wherein:
   H_{u,k} ∈ [symbol] (Nₜ, Nᵣ) denotes the channel matrix estimated based on SRS for UE with index u, at sub-carrier group (SCG) index k, wherein Nₜ denotes the number of antennas at the UE.
3) gNB pre-coder for beamforming (based on the SRS based channel estimation), wherein:

$${W}_{u , k}^{RAT} [ {R}_{i} ] ∈ ℂ ( {N}_{t} , {R}_{i} )$$

denotes the beamforming pre-coder for UE with index u, at sub-carrier group (SCG) index k, wherein Rᵢ denotes a hypothesized rank for the UE.
4) OLA value, wherein:
   OLA[Rᵢ] denotes the outer loop adjustment value in dB for the hypothesized rank Rᵢ. It should be noted that the OLA values for different ranks can be different (i.e., per-rank OLA) or can be identical (i.e., OLA common for all ranks).

### Step 1 (Calculation of Beamforming Gain Increment)

For each hypothesized rank Rᵢ, the beamforming gain increment is determined for using the gNB pre-coder instead of the pre-coder based on PMI of the feedback from UE. This is exemplified by two classes of beamforming gain increment determination:
One class (described as Solution 1 below) is based on calculation of the ratio of the signal power of the beamforming applied at gNB (i.e., the gNB pre-coder) over the signal power of the PMI based beamforming (i.e., the pre-coder based on PMI of the feedback from UE).
Another class (described as Solution 2 below) is based on calculation of the ratio of the equivalent channel matrix determinant of the beamforming applied at gNB (i.e., the gNB pre-coder) over the equivalent channel matrix determinant of the PMI based beamforming (i.e., the pre-coder based on PMI of the feedback from UE). The equivalent channel matrix determinant of the beamforming may be seen as an expression of downlink MIMO channel capacity for the corresponding pre-coder.

The calculation is exemplified below for each of the two classes; for a generalized arbitrary beamforming applied at gNB, as well as for an SVD pre-coder applied at gNB. The calculation for the generalized arbitrary beamforming can be applied also when an SVD pre-coder is applied at gNB, but the calculation especially configured for the SVD pre-coder may entail reduced calculation complexity compared.

The following notations are used to describe the beamforming gain increment determination:
The equivalent channel matrix for the codebook pre-coder, i.e., the pre-coder based on PMI of the feedback from UE with index u, at sub-carrier group (SCG) index k, is denoted by

$${H}_{u , k}^{PMI} = {H}_{u , k}^{T} {W}_{u , k}^{PMI} ∈ ℂ ( {N}_{r} , {RI}_{u}^{fb} ) ,$$

wherein (⋅)^{T} represents matrix transposition, and wherein the i^{th} column of

$${H}_{u , k}^{PMI}$$

is denoted by

$${h}_{u , k}^{PMI} ( i ) ∈ ℂ ( {N}_{r} , 1 ) , i = 1 , ... , {RI}_{u}^{fb} .$$

The equivalent channel matrix for the pre-coder applied at gNB for UE with index u, at sub-carrier group (SCG) index k, for rank with

$${RI}_{u}^{fb} ,$$

is denoted by

$${H}_{u , k}^{RAT} [ {RI}_{u}^{fb} ] = {H}_{u , k}^{T} {W}_{u , k}^{RAT} [ {RI}_{u}^{fb} ] ∈ ℂ ( {N}_{r} , {RI}_{u}^{fb} ) ,$$

wherein the i^{th} column of

$${H}_{u , k}^{RAT} [ {RI}_{u}^{fb} ]$$

is denoted by

$${h}_{u , k}^{RAT} [ {RI}_{u}^{fb} ] ( i ) ∈ ℂ ( {N}_{r} , 1 ) , i = 1 , ... , {RI}_{u}^{fb} .$$

The singular value decomposition (SVD) of the channel matrix can be expressed by

$${H}_{u , k}^{T} = {U}_{u , k} {D}_{u , k} {V}_{u , k}^{H} ,$$

wherein (⋅)^{H} represents Hermitian matrix transposition, wherein U_{u,k} ∈ [symbol] (Nᵣ, Nᵣ) and V_{u,k}∈ [symbol] (Nₜ, Nᵣ), and wherein the singular value matrix is denoted by D_{u,k}=diag{[d₁, . . . , d_{N}_{ᵣ}]} which has the singular values [d₁, . . . , d_{N}_{ᵣ}] ordered in descending order.

### Step 1, Solution 1: Signal Power Based Class of Beamforming Gain Increment Determination

In this approach, the beamforming gain increment is determined based on the ratio of the signal power of the beamforming applied at gNB (i.e., the gNB pre-coder) over the signal power of the PMI based beamforming (i.e., the pre-coder based on PMI of the feedback from UE).

The signal power of the beamforming applied at gNB depends on the number of layers based on RI of the feedback from UE. Therefore, one or more compensation terms may be applicable (typically a power normalization term—exemplified by the second term in equation (1) below, and an inter-layer interference term—exemplified by the second term in equation (1) below), wherein the compensation term(s) are based on a relation between the number of layers based on RI of the feedback from UE

$$( {RI}_{u}^{fb} )$$

and the hypothesized rank (Rt).

For an arbitrary beamforming/pre-coder applied at gNB, the beamforming gain increment forthe rank hypothesis Rᵢ may be determined using equation (1):

$${BFGain}_{u , k}^{{R}_{i}} = {SigRatio}_{u , k} + 10 {log}_{10} \frac{{RI}_{u}^{fb}}{{R}_{i}} + ILI * ( {RI}_{u}^{fb} - {R}_{i} ) .$$

The first term of equation (1) may be determined using equation (2):

$${SigRatio}_{u , k} = max \{ 0 , 10 {log}_{10} ( \frac{{P}_{u , k}^{RAT} [ {RI}_{u}^{fb} ]}{{P}_{u , k}^{PMI}} ) \} ,$$

wherein the signal power for the beamforming applied at gNB may be determined as

$${P}_{u , k}^{RAT} [ {RI}_{u}^{fb} ] = {\sum }_{i = 1}^{{RI}_{u}^{fb}} {α}_{u , k}^{RAT} [ {RI}_{u}^{fb} ] {( i )}^{2} {‖ {h}_{u , k}^{RAT} [ {RI}_{u}^{fb} ] ( i ) ‖}^{2} ,$$

the signal power for PMI based beamforming may be determined as

$${P}_{u , k}^{PMI} = {\sum }_{i = 1}^{{RI}_{u}^{fb}} {{α}_{u , k}^{PMI} ( i )}^{2} {‖ {h}_{u , k}^{PMI} ( i ) ‖}^{2} ,$$

and ∥⋅∥² denotes the squared Frobenius norm of a vector.

The scaling factors

$${α}_{u , k}^{RAT} [ {RI}_{u}^{fb} ] {( i )}^{2} and {{α}_{u , k}^{PMI} ( i )}^{2}$$

are introduced to account for signal power loss due to the possibility that there is still inter-layer interference after the beamforming. For example, for PMI based beamforming, the pre-coding matrix may be as one matrix from pre-defined codebook, which typically cannot cancel the inter-layer interference in a dynamic channel scenario as experienced by the UE. Alternatively, or additionally, even when the pre-coder applied at gNB is aims to fully cancel the inter-layer interference, there may be a mismatch (e.g., due to time varying channel conditions and/or noisy UL channel estimation) between the channel used for pre-coding calculation at gNB and the downlink channel as experienced by the UE so that inter-layer interference still exists.

It is possible for the UE to perform equalizing to cancel at least some of the inter-layer interference. For example, assuming that the UE zero-forces only the strongest power inter-layer interference component, closed form expressions for the scaling factors may be determined using equations (3) and (4):

$${α}_{u , k}^{RAT} [ {RI}_{u}^{fb} ] {( i )}^{2} = 1 - {max}_{j = 1 , ... {RI}_{u}^{fb} , j \neq i} \{ \frac{{\vert {( {h}_{u , k}^{RAT} [ {RI}_{u}^{fb} ] ( i ) )}^{H} {h}_{u , k}^{RAT} [ {RI}_{u}^{fb} ] ( j ) \vert}^{2}}{{‖ {h}_{u , k}^{RAT} [ {RI}_{u}^{fb} ] ( i ) ‖}^{2} {‖ {h}_{u , k}^{RAT} [ {RI}_{u}^{fb} ] ( j ) ‖}^{2}} \} , and$$

$${{α}_{u , k}^{PMI} ( i )}^{2} = 1 - {max}_{j = 1 , ... {RI}_{u}^{fb} , j \neq i} \{ \frac{{\vert {( {h}_{u , k}^{PMI} ( i ) )}^{H} {h}_{u , k}^{PMI} ( j ) \vert}^{2}}{{‖ {h}_{u , k}^{PMI} ( i ) ‖}^{2} {‖ {h}_{u , k}^{PMI} ( j ) ‖}^{2}} \} ,$$

where |·|² denotes the Euclidean norm of a complex number.

Taking the maximum in equation (2) corresponds to only considering positive beamforming gain increments for SINR adjustment.

The second term of equation (1) is a compensation term which accounts for the signal power difference associated with a difference between the number of layers based on RI of the feedback from UE

$$( {RI}_{u}^{fb} )$$

and the hypothesized rank (Rᵢ).

The third term of equation (1) is a compensation term which accounts for the inter-layer interference difference associated with a difference between the number of layers based on RI of the feedback from UE

$$( {RI}_{u}^{fb} )$$

and the hypothesized rank (Rᵢ), wherein the inter-layer interference parameter ILI is fixed.

It should be noted that the above expressions are merely intended as examples, and that numerous variations may be envisioned. For example, taking the maximum in equation (2) may be omitted. Alternatively or additionally, one or more of the compensation terms may be omitted, and/or other compensation terms may be used. Yet alternatively or additionally, other scaling factors may be applied.

Equations (1) and (2) may be seen as exemplifying the more general approach where the beamforming gain increment is determined based on a discrepancy (in this case; a ratio) between a first signal power and a second signal power, wherein the first signal power

$${P}_{u , k}^{RAT} [ {RI}_{u}^{fb} ]$$

corresponds to beamforming power for application of the uplink channel estimate based (e.g., reciprocity based) beamforming and the second signal power

$${P}_{u , k}^{PMI}$$

corresponds to beamforming power for application of user feedback based beamforming.

Equations (3) and (4) may be seen as exemplifying scaling factors for scaling of respective channel estimates.

The second and third terms of equation (1) may be seen as exemplifying compensation of the discrepancy for one or more modelling assumptions. For example, the second term of equation (1) may be seen as exemplifying compensation based on a difference between a number

$${RI}_{u}^{fb}$$

of MIMO layers associated with the user feedback and the hypothesized number Rᵢ of MIMO layers. Alternatively or additionally, the third term of equation (1) may be seen as exemplifying compensation based on an inter-layer interference.

For an SVD based beamforming/pre-coder applied at gNB, wherein the pre-coder applies the matrix V_{u,k} after SVD operation on the channel matrix

$${H}_{u , k}^{T} ,$$

the beamforming gain increment for the rank hypothesis Rᵢ may be determined using the same procedure as described above, but replacing

$${P}_{u , k}^{RAT} [ {RI}_{u}^{fb} ] = {\sum }_{i = 1}^{{RI}_{u}^{fb}} {α}_{u , k}^{RAT} [ {RI}_{u}^{fb} ] {( i )}^{2} {‖ {h}_{u , k}^{RAT} [ {RI}_{u}^{fb} ] ( i ) ‖}^{2}$$

with the simpler expression

$${P}_{u , k}^{RAT} [ {RI}_{u}^{fb} ] = {\sum }_{i = 1}^{{RI}_{u}^{fb}} {d}_{i}^{2} .$$

### Step 1, Solution 2: Determinant Based Class of Beamforming Gain Increment Determination

In this approach, the beamforming gain increment is determined based on the ratio of the determinant of the channel representation of the beamforming applied at gNB (i.e., the gNB pre-coder) over the determinant of the channel representation of the PMI based beamforming (i.e., the pre-coder based on PMI of the feedback from UE).

Generally, the determinant of the channel representation may be seen as a representation of the capacity of the channel (e.g., the Shannon capacity); under an assumption that the interference and noise is relatively small, such that it may be neglected in comparison with the signal power.

For an arbitrary beamforming/pre-coder applied at gNB, the beamforming gain increment for the rank hypothesis Rᵢ may be determined using equation (6):

$${BFGain}_{u , k}^{{R}_{i}} = 10 {log}_{10} ( \frac{det {\{ {( {H}_{u , k}^{T} {W}_{u , k}^{RAT} [ {R}_{i} ] )}^{H} {H}_{u , k}^{T} {W}_{u , k}^{RAT} [ {R}_{i} ] \}}^{\frac{1}{{R}_{i}}}}{det {\{ {( {H}_{u , k}^{T} {W}_{u , k}^{PMI} [ {RI}_{u}^{fb} ] )}^{H} {H}_{u , k}^{T} {W}_{u , k}^{PMI} [ {RI}_{u}^{fb} ] \}}^{\frac{1}{{RI}_{u}^{fb}}}} ) ,$$

where det(⋅) denotes matrix determinant.

Equation (6) may be seen as exemplifying the more general approach where the beamforming gain increment is determined based on a discrepancy (in this case; a ratio) between determinants of a first channel representation and a second channel representation, wherein the first channel representation

$${H}_{u , k}^{T} {W}_{u , k}^{RAT} [ {R}_{i} ]$$

corresponds to application of the uplink channel estimate based (e.g., reciprocity based) beamforming and the second channel representation

$${H}_{u , k}^{T} {W}_{u , k}^{PMI} [ {RI}_{u}^{fb} ]$$

corresponds to application of user feedback based beamforming.

For an SVD based beamforming/pre-coder applied at gNB, wherein the pre-coder applies the matrix V_{u,k} after SVD operation on the channel matrix

$${H}_{u , k}^{T} ,$$

the beamforming gain increment for the rank hypothesis Rᵢ may be determined using the simplified equation (7):

$${BFGain}_{u , k}^{{R}_{i}} = 10 {log}_{10} ( \frac{{\{ {\prod }_{i = 1}^{{R}_{i}} {d}_{i}^{2} \}}^{\frac{1}{{R}_{i}}}}{det {\{ {( {H}_{u , k}^{T} {W}_{u , k}^{PMI} [ {RI}_{u}^{fb} ] )}^{H} {H}_{u , k}^{T} {W}_{u , k}^{PMI} [ {RI}_{u}^{fb} ] \}}^{\frac{1}{{RI}_{u}^{fb}}}} ) .$$

### Step 2 (Per-SCG SINR Calculation)

The beamforming gain increment is used to adjust an SINR value associated with user feedback. In this approach, the SINR value associated with user feedback is exemplified by SINR based on CQI of the feedback from UE. The SINR based on CQI of the feedback from UE may be determined in any suitable way. For example, the CQI index of the feedback from UE may be mapped to SINR using a mapping table (e.g., a mapping table which is pre-known at gNB). The SINR based on CQI of the feedback from UE u, at sub-carrier group (SCG) index k, is denoted by

$$SIN {R}_{u , k}^{CQI}$$

(dB).

In this approach, the adjustment comprises applying equation (8):

$$SIN {R}_{u , k} [ {R}_{i} ] = SIN {R}_{u , k}^{CQI} + {BFGain}_{u , k}^{{R}_{i}} ,$$

when condition 1 and condition 2 (specified below) are satisfied. The resulting adjusted value is denoted by SINR_{u,k}[Rᵢ] for rank hypothesis Rᵢ. When any, or both, of condition 1 and condition 2 are not satisfied, the SINR based on CQI of the feedback from UE

$$( i . e . , SIN {R}_{u , k}^{CQI} )$$

can be used directly for rank selection and link adaptation.
Condition 1: The OLA value is positive. Thus, when the previous transmission was successful, it may be beneficial to increase the SINR value to get a higher MCS and/or a higher rank for the upcoming downlink transmission. On the other hand, when the previous transmission failed (e.g., because the corresponding MCS and/or rank were too aggressive), it is typically not beneficial to increase the SINR by adding the beamforming gain increment.
Condition 2: The UL channel estimation is available for all SRS ports. Otherwise, it is typically not possible to calculate an accurate pre-coder matrix and a proper SINR that match the downlink channel conditions (e.g., the conditions for the uplink channel estimate based beamforming that is used for DL transmission may not be sufficiently similar to the conditions under which the feedback based SINR was determined; so that

$$SIN {R}_{u , k}^{CQI}$$

cannot be matched to

$${BFGain}_{u , k}^{{R}_{i}}$$

in a useful way).

It should be noted that the above conditions are merely intended as examples, and that numerous variations may be envisioned. For example, one or more of condition 1 and condition 2 may be omitted, and/or other condition(s) may be used. Other example conditions include that an SINR value

$$( e . g . , SIN {R}_{u , k}^{CQI}$$

or the SINR estimated based on SRS) is lower than a threshold value. Equation (8) may be seen as exemplifying the more general approach where an SINR value associated with the user feedback is adjusted based on the beamforming gain increment.

### Step 3 (Rank Selection and Link Adaptation)

In this approach, the adjusted SINR is used for rank selection and link adaptation. It should be noted that this is merely intended as examples, and that numerous variations may be envisioned for using the adjusted SINR. For example, the adjusted SINR may be used of only one, or none, of rank selection and link adaptation, and/or the adjusted SINR may be used for other purposes.

Regarding rank selection, the per-SCG SINR calculated in Step 2 can be used together with any suitable approach for rank selection (e.g., converting the per-SCG SINR to per-codeword SINR and apply a known approach for rank selection). In the following, one typical approach for SINR conversion and rank selection is described. It should be noted that this is merely intended as an example, and that other approaches may be equally applicable.
For each rank hypothesis RIᵢ, and for each SCG, the information carried per carrier (ICC) of each SCG, ICC_{R}_{ᵢ}_{,k}(mod), is determined (e.g., by any known function, denoted as SINR2ICC(⋅)):

$${ICC}_{{R}_{i} , k} ( mod ) = SIN R 2 ICC ( SIN {R}_{u , k} [ {R}_{i} ] , mod ) , mod ∈ ℳ ,$$

where mod represents a modulation order, and [symbol] is the set of all possible modulation orders enabled for the UE. The function SINR2ICC(⋅) can be some mathematical equation (e.g., an expression for channel capacity) or a look-up table, for example.
The total ICC over all SCGs, ICC_{R}_{ᵢ}(mod), is determined for each rank hypothesis RIᵢ, and the modulation order modₘₐₓ that corresponds to the maximum ICC, ICC_{R}_{ᵢ}(modₘₐₓ), is found:

$${ICC}_{{R}_{i}} ( mod ) = \frac{1}{{N}_{scg} {R}_{i}} {\sum }_{k = 1}^{{N}_{scg}} {ICC}_{{R}_{i} , k} ( mod ) ,$$

$${ICC}_{{R}_{i}} ( {mod}_{max} ) = {max}_{mod ∈ ℳ} ( {ICC}_{{R}_{i}} ( mod ) ) ,$$

where N_{scg} denotes the number of SCGs for transmission to the UE.
For each rank hypothesis RIᵢ, the maximum ICC is converted back to a corresponding per-codeword SINR

$${\hat{γ}}_{u}^{{R}_{i}}$$

(e.g., by any known function, denoted as ICC2SINR(⋅)):

$${\hat{γ}}_{u}^{{R}_{i}} = ICC 2 SIN R ( {ICC}_{{R}_{i}} ( {mod}_{max} ) ) .$$

The function ICC2SINR(⋅) can be some mathematical equation or a look-up table, for example.
The OLA value is added to the per-codeword SINR for each rank hypothesis RIᵢ:

$${\hat{γ}}_{u , OLA}^{{R}_{i}} = {\hat{γ}}_{u}^{{R}_{i}} + OLA [ {R}_{i} ] .$$

For each rank hypothesis RIᵢ, the resulting SINR

$${\hat{γ}}_{u , OLA}^{{R}_{i}}$$

is converted to ICC, and the rank [symbol] ᵤ that corresponds to the maximum ICC is selected:

$${ICC}_{{R}_{i} , OLA} ( mod ) = SIN R 2 ICC ( {\hat{γ}}_{u , OLA}^{{R}_{i}} , mod ) , mod ∈ ℳ ,$$

$${ICC}_{{R}_{i} , OLA} = {max}_{mod ∈ ℳ} ( {ICC}_{{R}_{i} , OLA} ( mod ) ) , and$$

$${u}_{} = arg {max}_{{R}_{i} ∈ \{ 1 , ... , {N}_{r} \}} ( {ICC}_{{R}_{i} , OLA} ) .$$

Regarding link adaptation, the per-SCG SINR calculated in Step 2 for the selected rank (i.e., SINR_{u,k}[ [symbol] ᵤ]) can be used for link adaptation (e.g., for MCS selection).

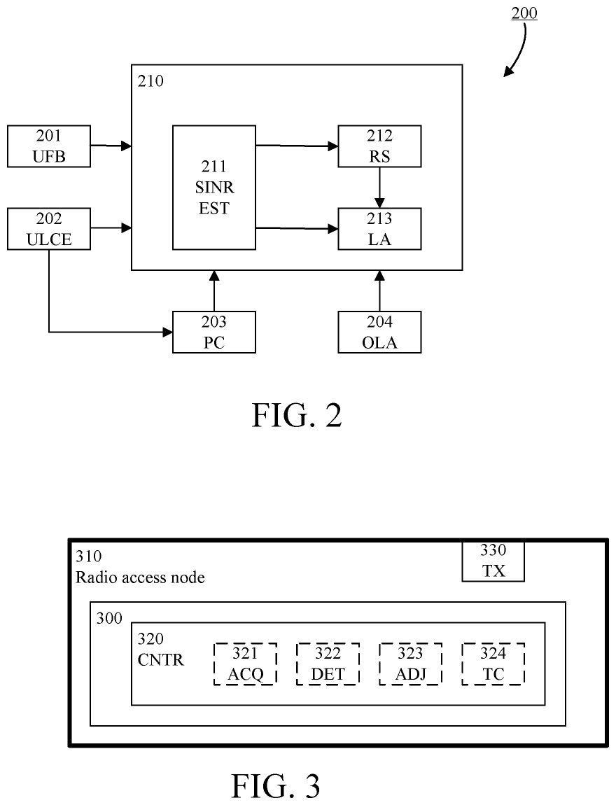

FIG. 2 schematically illustrates example functions according to some embodiments in the form of a functional arrangement 200. For example, the functional arrangement 200 may be seen as an exemplification of the method 100 of FIG. 1. Alternatively or additionally, the functional arrangement 200 may be seen as an exemplification of an architecture for the apparatus 300 of FIG. 3 (to be described later herein).

According to FIG. 2, a function 210 uses user feedback (UFB) 201, uplink channel estimation (ULCE) 202, downlink transmitter pre-coder (PC) 203 and outer loop adjustment values (OLA) 204 to perform SINR estimation (SINR EST) 211. The downlink transmitter pre-coder may be based on the uplink channel estimation.

The estimated SINR is used for rank selection (RS) 212 and link adaptation (LA) 213. The link adaptation may additionally be based on the selected rank.

For example, blocks 201, 202, 203, 204 may be compared to sub-steps 112, 114, 116, 118 (respectively) of FIG. 1 (see also step 0 of the above example), and/or to the acquirer 321 of FIG. 3.

Alternatively or additionally, block 211 may be compared to steps 130 and 140 of FIG. 1 (see also step 1 and step 2 of the above example), and/or to the determiner 322 and the adjuster 323 of FIG. 3.

Yet alternatively or additionally, blocks 212, 213 may be compared to sub-steps 154, 152 (respectively) of FIG. 1 (see also step 3 of the above example), and/or to the transmission controller 324 of FIG. 3.

FIG. 3 schematically illustrates an example apparatus 300 according to some embodiments. The apparatus 300 is for a radio access node configured for communication with a plurality of users by multiple-input multiple-output (MIMO) transmission.

For example, the apparatus 300 may be comprised in the radio access node 310 as illustrated in FIG. 3, in a server node (e.g., a central network node or a cloud server) controlling the radio access node, or in a control node configured to control a plurality of access points of a distributed MIMO system.

Alternatively or additionally, the apparatus 300 may be configured to execute, or cause execution of, one or more method steps as described in connection with the method 100 of FIG. 1.

In any case, the radio access node is configured to receive user feedback indicative of downlink channel estimates. The radio access node is also configured to use uplink channel estimates for uplink channel estimate based (e.g., reciprocity based) beamforming of the MIMO transmission.

The apparatus 300 comprises a controller (CNTR; e.g., controlling circuitry or a control module) 320.

The controller 320 is configured to cause determination of a beamforming gain increment achievable by use of the downlink channel estimates for beamforming of the MIMO transmission (compare with step 130 of FIG. 1).

To this end, the controller 320 may comprise, or be otherwise associated with (e.g., connected, or connectable, to) a determiner (DET; e.g., determining circuitry or a determination module) 322. The determiner 322 may be configured to determine the beamforming gain increment.

The controller 320 is also configured to cause adjustment (based on the beamforming gain increment) of an SIR value and/or an SINR value associated with the user feedback (compare with step 140 of FIG. 1).

To this end, the controller 320 may comprise, or be otherwise associated with (e.g., connected, or connectable, to) an adjuster (ADJ; e.g., adjusting circuitry or an adjustment module) 323. The adjuster 323 may be configured to adjust the SIR value and/or the SINR value based on the beamforming gain increment.

The controller 320 is also configured to cause DL MIMO transmission to one or more user of the plurality of users based on the adjusted SIR value and/or SINR value (compare with step 160 of FIG. 1).

To this end, the controller 320 may comprise, or be otherwise associated with (e.g., connected, or connectable, to) a transmitter (TX; e.g., transmitting circuitry or a transmission module) 330 of the radio access node. The transmitter 330 may be configured to perform the DL MIMO transmission. It should be noted that, when the apparatus 300 is comprised in another node than the radio access node, the controller 320 may be associated with the transmitter via a connection between the node comprising the controller 320 and the radio access node.

In some embodiments, the controller 320 may be configured to cause the adjusted SIR value and/or SINR value to be used for controlling MIMO configuration of an upcoming transmission occasion (compare with step 150 of FIG. 1). For example, the controller 320 may be configured to cause the adjusted SIR value and/or SINR value to be used for one or more of: MU grouping, link adaptation, and MIMO rank selection.

To this end, the controller 320 may comprise, or be otherwise associated with (e.g., connected, or connectable, to) a transmission controller (TC; e.g., transmission controlling circuitry or a transmission control module) 324. The transmission controller 324 may be configured to control MIMO configuration of an upcoming transmission occasion based on the adjusted SIR value and/or SINR value.

In some embodiments, the controller 320 may be configured to cause acquisition of information such as—for example—user feedback, UL measurements, BF setting, and OLA setting (compare with step 110 of FIG. 1).

To this end, the controller 320 may comprise, or be otherwise associated with (e.g., connected, or connectable, to) an acquirer (ACQ; e.g., acquiring circuitry or an acquisition module) 321. The acquirer 321 may be configured to acquire the information.

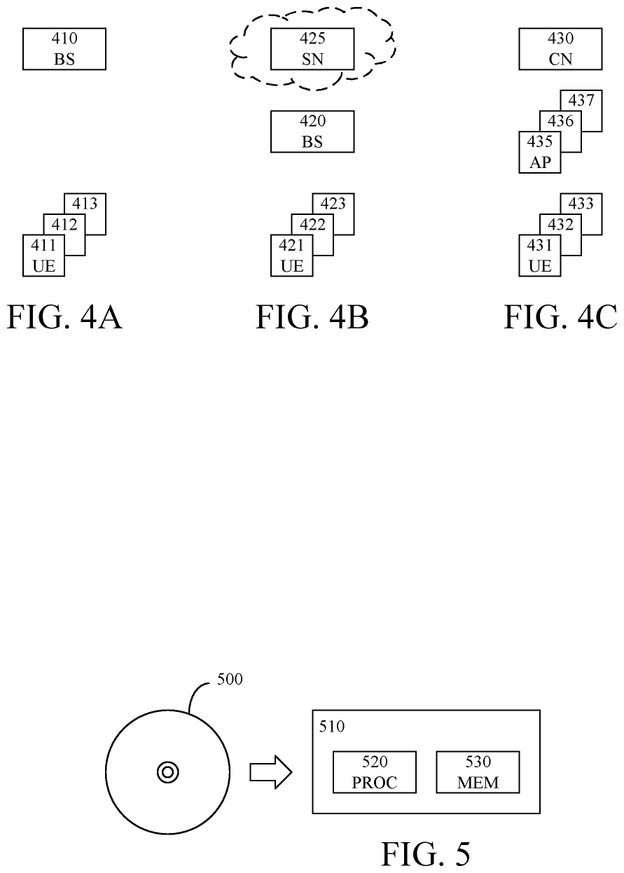

FIG. 4A schematically illustrates an example communication scenario according to some embodiments. The scenario of FIG. 4A comprises a radio access node in the form of a base station (BS) 410 and a plurality of users in the form of UEs 411, 412, 413.

The BS 410 may be configured to communicate with the UEs 411, 412, 413 by MIMO transmission. To this end, the BS 410 may comprise the apparatus 300 of FIG. 3. Alternatively or additionally, the BS 410 may be configured to execute one or more steps of the method 100 of FIG. 1.

FIG. 4B schematically illustrates an example communication scenario according to some embodiments. The scenario of FIG. 4B comprises a radio access node in the form of a base station (BS) 420 and a plurality of users in the form of UEs 421, 422, 423. The scenario of FIG. 4B also comprises a server node (SN) 425. For example, the SN 425 may be a central network node or a cloud server.

The BS 420 may be configured to communicate with the UEs 421, 422, 423 by MIMO transmission; under the control of the SN 425. To this end, the SN 425 may comprise the apparatus 300 of FIG. 3. Alternatively or additionally, the SN 425 may be configured to execute one or more steps of the method 100 of FIG. 1.

Referring to FIG. 1, the SN 425 may, for example, be configured to perform step 130 and provide the beamforming gain increment(s) to the BS 420, while the BS 420 is configured to perform steps 140 and 160. Alternatively, the SN 425 may be configured to perform steps 130 and 140 and provide the adjusted SIR value(s) and/or SINR value(s) to the BS 420, while the BS 420 is configured to perform step 160. Yet alternatively, the SN 425 may be configured to perform steps 130, 140, 150 and provide the MIMO configuration (e.g., one or more of: MCS, number of layers, and MU grouping) to the BS 420, while the BS 420 is configured to perform the transmission part of step 160.

FIG. 4C schematically illustrates an example communication scenario according to some embodiments. The scenario of FIG. 4C comprises a plurality of radio access nodes in the form of access points (AP) 435, 436, 437 of a distributed MIMO system, and a plurality of users in the form of UEs 431, 432, 433. The scenario of FIG. 4C also comprises a control node (CN) 430 of the distributed MIMO system, which is configured to control the APs 435, 436, 437.

The distributed MIMO system may be configured to communicate with the UEs 431, 432, 433 by MIMO transmission; under the control of the CN 430. To this end, the CN 430 may comprise the apparatus 300 of FIG. 3. Alternatively or additionally, the CN 430 may be configured to execute one or more steps of the method 100 of FIG. 1.

Referring to FIG. 1, the CN 430 may, for example, be configured to perform step 130 and provide the beamforming gain increment(s) to the relevant AP(s) 435, 436, 437, which are configured to perform steps 140 and 160. Alternatively, the CN 430 may be configured to perform steps 130 and 140 and provide the adjusted SIR value(s) and/or SINR value(s) to the relevant AP(s) 435, 436, 437, which are configured to perform step 160. Yet alternatively, the CN 430 may be configured to perform steps 130, 140, 150 and provide the MIMO configuration (e.g., one or more of: MCS, number of layers, and MU grouping) to the relevant AP(s) 435, 436, 437, which are configured to perform the transmission part of step 160.

It should be noted that features and/or advantages described herein in connection with any of the Figures is equally applicable (as suitable) for any other Figure, even if not explicitly mentioned in connection thereto.

The described embodiments and their equivalents may be realized in software or hardware or a combination thereof. The embodiments may be performed by general purpose circuitry. Examples of general purpose circuitry include digital signal processors (DSP), central processing units (CPU), co-processor units, field programmable gate arrays (FPGA) and other programmable hardware. Alternatively or additionally, the embodiments may be performed by specialized circuitry, such as application specific integrated circuits (ASIC). The general purpose circuitry and/or the specialized circuitry may, for example, be associated with or comprised in an apparatus such as a radio access node, a server node, or a distributed MIMO control node. Embodiments may appear within an electronic apparatus (such as a radio access node, a server node, or a distributed MIMO control node) comprising arrangements, circuitry, and/or logic according to any of the embodiments described herein. Alternatively or additionally, an electronic apparatus (such as a radio access node, a server node, or a distributed MIMO control node) may be configured to perform methods according to any of the embodiments described herein.

According to some embodiments, a computer program product comprises a non-transitory computer readable medium such as, for example, a universal serial bus (USB) memory, a plug-in card, an embedded drive, or a read only memory (ROM). FIG. 5 illustrates an example computer readable medium in the form of a compact disc (CD) ROM 500. The computer readable medium has stored thereon a computer program comprising program instructions. The computer program is loadable into a data processor (PROC; e.g., a data processing unit) 520, which may, for example, be comprised in a device 510 (e.g., a radio access node, a server node, or a distributed MIMO control node). When loaded into the data processor, the computer program may be stored in a memory (MEM) 530 associated with, or comprised in, the data processor. According to some embodiments, the computer program may, when loaded into, and run by, the data processor, cause execution of method steps according to, for example, the method illustrated in FIG. 1, or as otherwise described herein.

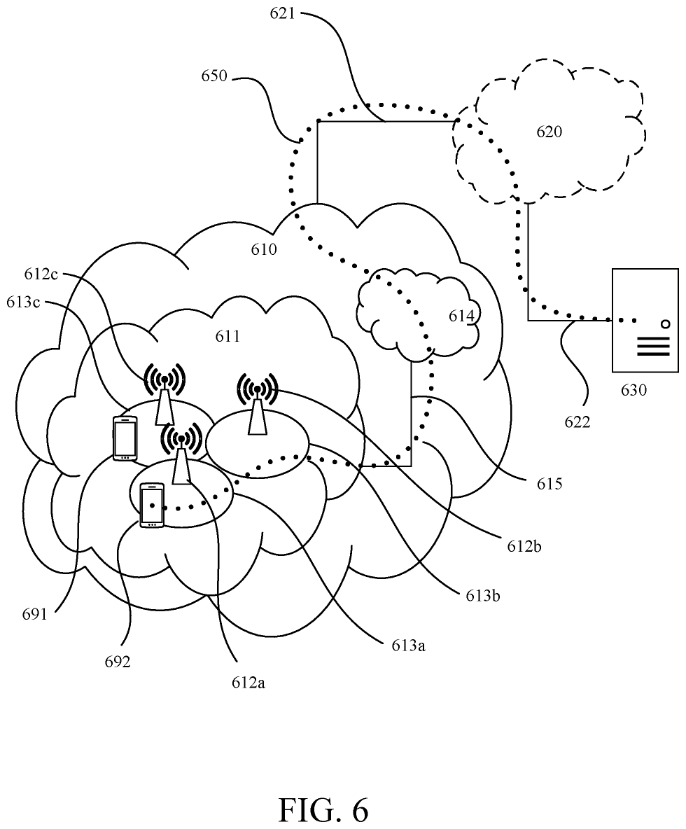

With reference to FIG. 6, in accordance with an embodiment, a communication system includes a telecommunication network 610, such as a 3GPP-type cellular network, which comprises an access network 611, such as a radio access network, and a core network 614. The access network 611 comprises a plurality of base stations 612a, 612b, 612c, such as NBs, eNBs, gNBs or other types of wireless access points, each defining a corresponding coverage area 613a, 613b, 613c. Each base station 612a, 612b, 612c is connectable to the core network 614 over a wired or wireless connection 615. A first user equipment (UE) 691 located in coverage area 613c is configured to wirelessly connect to, or be paged by, the corresponding base station 612c. A second UE 692 in coverage area 613a is wirelessly connectable to the corresponding base station 612a. While a plurality of UEs 691, 692 are illustrated in this example, the disclosed embodiments are equally applicable to a situation where a sole UE is in the coverage area or where a sole UE is connecting to the corresponding base station 612.

The telecommunication network 610 is itself connected to a host computer 630, which may be embodied in the hardware and/or software of a standalone server, a cloud-implemented server, a distributed server or as processing resources in a server farm. The host computer 630 may be under the ownership or control of a service provider, or may be operated by the service provider or on behalf of the service provider. The connections 621, 622 between the telecommunication network 610 and the host computer 630 may extend directly from the core network 614 to the host computer 630 or may go via an optional intermediate network 620. The intermediate network 620 may be one of, or a combination of more than one of, a public, private or hosted network; the intermediate network 620, if any, may be a backbone network or the Internet; in particular, the intermediate network 620 may comprise two or more sub-networks (not shown).

The communication system of FIG. 6 as a whole enables connectivity between one of the connected UEs 691, 692 and the host computer 630. The connectivity may be described as an over-the-top (OTT) connection 650. The host computer 630 and the connected UEs 691, 692 are configured to communicate data and/or signaling via the OTT connection 650, using the access network 611, the core network 614, any intermediate network 620 and possible further infrastructure (not shown) as intermediaries. The OTT connection 650 may be transparent in the sense that the participating communication devices through which the OTT connection 650 passes are unaware of routing of uplink and downlink communications. For example, a base station 612 may not or need not be informed about the past routing of an incoming downlink communication with data originating from a host computer 630 to be forwarded (e.g., handed over) to a connected UE 691. Similarly, the base station 612 need not be aware of the future routing of an outgoing uplink communication originating from the UE 691 towards the host computer 630.

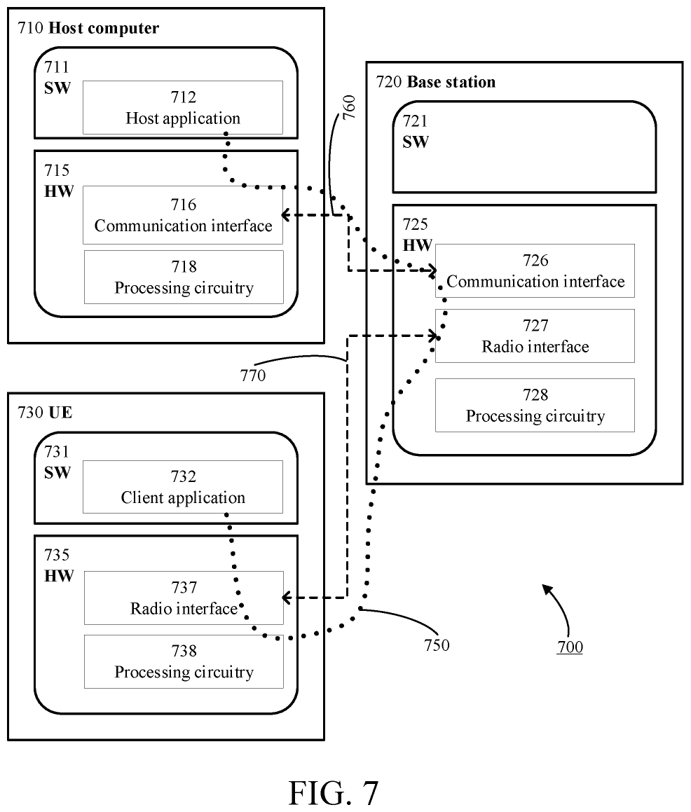

Example implementations, in accordance with an embodiment, of the UE, base station and host computer discussed in the preceding paragraphs will now be described with reference to FIG. 7. In a communication system 700, a host computer 710 comprises hardware 715 including a communication interface 716 configured to set up and maintain a wired or wireless connection with an interface of a different communication device of the communication system 700. The host computer 710 further comprises processing circuitry 718, which may have storage and/or processing capabilities. In particular, the processing circuitry 718 may comprise one or more programmable processors, application-specific integrated circuits, field programmable gate arrays or combinations of these (not shown) adapted to execute instructions. The host computer 710 further comprises software 711, which is stored in or accessible by the host computer 710 and executable by the processing circuitry 718. The software 711 includes a host application 712. The host application 712 may be operable to provide a service to a remote user, such as a UE 730 connecting via an OTT connection 750 terminating at the UE 730 and the host computer 710. In providing the service to the remote user, the host application 712 may provide user data which is transmitted using the OTT connection 750.

The communication system 700 further includes a base station 720 provided in a telecommunication system and comprising hardware 725 enabling it to communicate with the host computer 710 and with the UE 730. The hardware 725 may include a communication interface 726 for setting up and maintaining a wired or wireless connection with an interface of a different communication device of the communication system 700, as well as a radio interface 727 for setting up and maintaining at least a wireless connection 770 with a UE 730 located in a coverage area (not shown in FIG. 7) served by the base station 720. The communication interface 726 may be configured to facilitate a connection 760 to the host computer 710. The connection 760 may be direct or it may pass through a core network (not shown in FIG. 7) of the telecommunication system and/or through one or more intermediate networks outside the telecommunication system. In the embodiment shown, the hardware 725 of the base station 720 further includes processing circuitry 728, which may comprise one or more programmable processors, application-specific integrated circuits, field programmable gate arrays or combinations of these (not shown) adapted to execute instructions. The base station 720 further has software 721 stored internally or accessible via an external connection.

The communication system 700 further includes the UE 730 already referred to. Its hardware 735 may include a radio interface 737 configured to set up and maintain a wireless connection 770 with a base station serving a coverage area in which the UE 730 is currently located. The hardware 735 of the UE 730 further includes processing circuitry 738, which may comprise one or more programmable processors, application-specific integrated circuits, field programmable gate arrays or combinations of these (not shown) adapted to execute instructions. The UE 730 further comprises software 731, which is stored in or accessible by the UE 730 and executable by the processing circuitry 738. The software 731 includes a client application 732. The client application 732 may be operable to provide a service to a human or non-human user via the UE 730, with the support of the host computer 710. In the host computer 710, an executing host application 712 may communicate with the executing client application 732 via the OTT connection 750 terminating at the UE 730 and the host computer 710. In providing the service to the user, the client application 732 may receive request data from the host application 712 and provide user data in response to the request data. The OTT connection 750 may transfer both the request data and the user data. The client application 732 may interact with the user to generate the user data that it provides.

It is noted that the host computer 710, base station 720 and UE 730 illustrated in FIG. 7 may be identical to the host computer 630, one of the base stations 612a, 612b, 612c and one of the UEs 691, 692 of FIG. 6, respectively. This is to say, the inner workings of these entities may be as shown in FIG. 7 and independently, the surrounding network topology may be that of FIG. 6.

In FIG. 7, the OTT connection 750 has been drawn abstractly to illustrate the communication between the host computer 710 and the use equipment 730 via the base station 720, without explicit reference to any intermediary devices and the precise routing of messages via these devices. Network infrastructure may determine the routing, which it may be configured to hide from the UE 730 or from the service provider operating the host computer 710, or both. While the OTT connection 750 is active, the network infrastructure may further take decisions by which it dynamically changes the routing (e.g., on the basis of load balancing consideration or reconfiguration of the network).

The wireless connection 770 between the UE 730 and the base station 720 is in accordance with the teachings of the embodiments described throughout this disclosure. One or more of the various embodiments improve the performance of OTT services provided to the UE 730 using the OTT connection 750, in which the wireless connection 770 forms the last segment. More precisely, the teachings of these embodiments may improve the throughput and thereby provide benefits such as one or more of: reduced user waiting time, relaxed restriction on file size, and better responsiveness.

A measurement procedure may be provided for the purpose of monitoring data rate, latency and other factors on which the one or more embodiments improve. There may further be an optional network functionality for reconfiguring the OTT connection 750 between the host computer 710 and UE 730, in response to variations in the measurement results. The measurement procedure and/or the network functionality for reconfiguring the OTT connection 750 may be implemented in the software 711 of the host computer 710 or in the software 731 of the UE 730, or both. In embodiments, sensors (not shown) may be deployed in or in association with communication devices through which the OTT connection 750 passes; the sensors may participate in the measurement procedure by supplying values of the monitored quantities exemplified above, or supplying values of other physical quantities from which software 711, 731 may compute or estimate the monitored quantities. The reconfiguring of the OTT connection 750 may include message format, retransmission settings, preferred routing etc.; the reconfiguring need not affect the base station 720, and it may be unknown or imperceptible to the base station 720. Such procedures and functionalities may be known and practiced in the art. In certain embodiments, measurements may involve proprietary UE signaling facilitating the host computer's 710 measurements of throughput, propagation times, latency and the like. The measurements may be implemented in that the software 711, 731 causes messages to be transmitted, in particular empty or ‘dummy’ messages, using the OTT connection 750 while it monitors propagation times, errors etc.

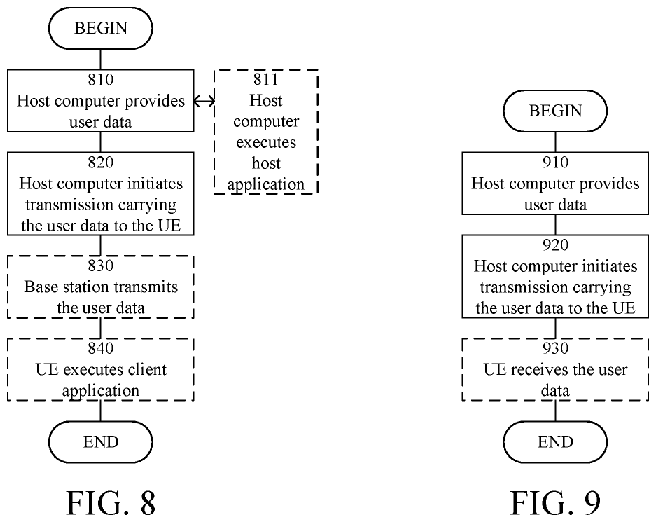

FIG. 8 is a flowchart illustrating a method implemented in a communication system, in accordance with one embodiment. The communication system includes a host computer, a base station and a UE which may be those described with reference to FIGS. 6 and 7. For simplicity of the present disclosure, only drawing references to FIG. 8 will be included in this section. In a first step 810 of the method, the host computer provides user data. In an optional sub-step 811 of the first step 810, the host computer provides the user data by executing a host application. In a second step 820, the host computer initiates a transmission carrying the user data to the UE. In an optional third step 830, the base station transmits to the UE the user data which was carried in the transmission that the host computer initiated, in accordance with the teachings of the embodiments described throughout this disclosure. In an optional fourth step 840, the UE executes a client application associated with the host application executed by the host computer.

FIG. 9 is a flowchart illustrating a method implemented in a communication system, in accordance with one embodiment. The communication system includes a host computer, a base station and a UE which may be those described with reference to FIGS. 6 and 7. For simplicity of the present disclosure, only drawing references to FIG. 9 will be included in this section. In a first step 910 of the method, the host computer provides user data. In an optional sub-step (not shown) the host computer provides the user data by executing a host application. In a second step 920, the host computer initiates a transmission carrying the user data to the UE. The transmission may pass via the base station, in accordance with the teachings of the embodiments described throughout this disclosure. In an optional third step 930, the UE receives the user data carried in the transmission.

Generally, all terms used herein are to be interpreted according to their ordinary meaning in the relevant technical field, unless a different meaning is clearly given and/or is implied from the context in which it is used.

Reference has been made herein to various embodiments. However, a person skilled in the art would recognize numerous variations to the described embodiments that would still fall within the scope of the claims.

For example, the method embodiments described herein discloses example methods through steps being performed in a certain order. However, it is recognized that these sequences of events may take place in another order without departing from the scope of the claims. Furthermore, some method steps may be performed in parallel even though they have been described as being performed in sequence. Thus, the steps of any methods disclosed herein do not have to be performed in the exact order disclosed, unless a step is explicitly described as following or preceding another step and/or where it is implicit that a step must follow or precede another step.

In the same manner, it should be noted that in the description of embodiments, the partition of functional blocks into particular units is by no means intended as limiting. Contrarily, these partitions are merely examples. Functional blocks described herein as one unit may be split into two or more units. Furthermore, functional blocks described herein as being implemented as two or more units may be merged into fewer (e.g. a single) unit.

Any feature of any of the embodiments disclosed herein may be applied to any other embodiment, wherever suitable. Likewise, any advantage of any of the embodiments may apply to any other embodiments, and vice versa.

Hence, it should be understood that the details of the described embodiments are merely examples brought forward for illustrative purposes, and that all variations that fall within the scope of the claims are intended to be embraced therein.

### Some Numbered Embodiments

1. A base station configured to communicate with a user equipment (UE), wherein the base station is a radio access node configured for communication with a plurality of users by multiple-input multiple-output, MIMO, transmission, wherein the UE is one of the plurality of users, wherein the radio access node is configured to receive user feedback indicative of downlink channel estimates, and wherein the radio access node is configured to use uplink channel estimates for uplink channel estimate based beamforming of the MIMO transmission, the base station comprising a radio interface and processing circuitry configured to:
   determine a beamforming gain increment achievable by using the downlink channel estimates for beamforming of the MIMO transmission;
   adjust—based on the beamforming gain increment—a signal-to-interference ratio, SIR, value and/or a signal-to-interference-and-noise ratio, SINR, value associated with the user feedback; and
   perform downlink, DL, MIMO transmission to the UE based on the adjusted SIR value and/or SINR value.
2. A communication system including a host computer comprising:
   processing circuitry configured to provide user data; and
   a communication interface configured to forward the user data to a cellular network for transmission to a user equipment (UE),
   wherein the cellular network comprises a base station configured to communicate with the UE, wherein the base station is a radio access node configured for communication with a plurality of users by multiple-input multiple-output, MIMO, transmission, wherein the UE is one of the plurality of users, wherein the radio access node is configured to receive user feedback indicative of downlink channel estimates, and wherein the radio access node is configured to use uplink channel estimates for uplink channel estimate based beamforming of the MIMO transmission, the base station having a radio interface and processing circuitry, the base station's processing circuitry configured to:
   determine a beamforming gain increment achievable by using the downlink channel estimates for beamforming of the MIMO transmission;
   adjust—based on the beamforming gain increment—a signal-to-interference ratio, SIR, value and/or a signal-to-interference-and-noise ratio, SINR, value associated with the user feedback; and
   perform downlink, DL, MIMO transmission to the UE based on the adjusted SIR value and/or SINR value.
3. The communication system of embodiment 2, further including the base station.
4. The communication system of embodiment 3, further including the UE, wherein the UE is configured to communicate with the base station.
5. The communication system of embodiment 4, wherein:
   the processing circuitry of the host computer is configured to execute a host application, thereby providing the user data; and
   the UE comprises processing circuitry configured to execute a client application associated with the host application.
6. A method implemented in a base station configured to communicate with a user equipment (UE), wherein the base station is a radio access node configured for communication with a plurality of users by multiple-input multiple-output, MIMO, transmission, wherein the UE is one of the plurality of users, wherein the radio access node is configured to receive user feedback indicative of downlink channel estimates, and wherein the radio access node is configured to use uplink channel estimates for uplink channel estimate based beamforming of the MIMO transmission, the method comprising:
   determining a beamforming gain increment achievable by using the downlink channel estimates for beamforming of the MIMO transmission;
   adjusting—based on the beamforming gain increment—a signal-to-interference ratio, SIR, value and/or a signal-to-interference-and-noise ratio, SINR, value associated with the user feedback; and performing downlink, DL, MIMO transmission to the UE based on the adjusted SIR value and/or SINR value.
7. A method implemented in a communication system including a host computer, a base station and a user equipment (UE), wherein the base station is configured to communicate with the UE, wherein the base station is a radio access node configured for communication with a plurality of users by multiple-input multiple-output, MIMO, transmission, wherein the UE is one of the plurality of users, wherein the radio access node is configured to receive user feedback indicative of downlink channel estimates, and wherein the radio access node is configured to use uplink channel estimates for uplink channel estimate based beamforming of the MIMO transmission, the method comprising:
   at the host computer, providing user data; and
   at the host computer, initiating a transmission carrying the user data to the UE via a cellular network comprising the base station, wherein the base station:
   determines a beamforming gain increment achievable by using the downlink channel estimates for beamforming of the MIMO transmission;
   adjusts—based on the beamforming gain increment—a signal-to-interference ratio, SIR, value and/or a signal-to-interference-and-noise ratio, SINR, value associated with the user feedback; and
   performs downlink, DL, MIMO transmission to the UE based on the adjusted SIR value and/or SINR value.
8. The method of embodiment 7, further comprising:
   at the base station, transmitting the user data.
9. The method of embodiment 8, wherein the user data is provided at the host computer by executing a host application, the method further comprising:
   at the UE, executing a client application associated with the host application.

1-52. (canceled)

53. A method for a radio access node, for communicating with a plurality of users by multiple-input multiple-output (MIMO) transmission, wherein the radio access node is configured to receive user feedback indicative of downlink channel estimates, and wherein the radio access node is configured to use uplink channel estimates for uplink channel estimate based beamforming of the MIMO transmission, the method comprising:
determining a beamforming gain increment achievable by using the downlink channel estimates for beamforming of the MIMO transmission, the beamforming gain incremented determined based either on a discrepancy between determinants of a first channel representation and a second channel representation, wherein the first channel representation corresponds to application of the uplink channel estimate based beamforming and the second channel representation corresponds to application of user feedback based beamforming, or a discrepancy between a first signal power and a second signal power, wherein the first signal power corresponds to beamforming power for application of the uplink channel estimate based beamforming and the second signal power corresponds to beamforming power for application of user feedback based beamforming;
adjusting, based on the beamforming gain increment, a signal-to-interference ratio (SIR) value and/or a signal-to-interference-and-noise ratio (SINR) value associated with the user feedback; and
performing or causing downlink (DL) MIMO transmission to one or more user of the plurality of users based on the adjusted SIR value and/or SINR value.

54. The method of claim 53, wherein the DL MIMO transmission is a single-user (SU) MIMO transmission or a multi-user (MU) MIMO transmission.

55. The method of claim 53, wherein the DL MIMO transmission is a multi-user (MU) MIMO transmission and comprises dynamic MU grouping over time, with the adjusted SIR value and/or SINR value used for the MU grouping.

56. The method of claim 55, wherein the downlink channel estimates are associated with a MU grouping used at a previous transmission occasion.

57. The method of claim 55, wherein the beamforming gain increment is determined for each of a collection of MU grouping hypotheses.

58. The method of claim 53, further comprising using the adjusted SIR value and/or SINR value for controlling a MIMO configuration of an upcoming transmission occasion.

59. The method of claim 53, wherein further comprising using the adjusted SIR value and/or SINR value for link adaptation and/or MIMO rank selection.

60. The method of claim 59, wherein using the adjusted SIR value and/or SINR value for MIMO rank selection comprises:
for each of a plurality of hypothesized ranks, calculating a respective amount of information carried per sub-carrier based on the adjusted SIR value and/or SINR value; and
performing rank selection among the plurality of hypothesized ranks based on the respective amount of information carried per sub-carrier.

61. The method of claim 60, wherein performing rank selection comprises selecting the hypothesized rank which has the highest respective amount of information carried per sub-carrier among the plurality of hypothesized ranks.

62. The method of claim 59, wherein using the adjusted SIR value and/or SINR value for link adaptation comprises selecting a modulation and coding scheme (MCS) that is associated with the adjusted SIR value and/or SINR value.

63. The method of claim 53, wherein the beamforming gain increment comprises a plurality of respective beamforming gain increments, each respective beamforming gain increment corresponding to a hypothesized number of MIMO layers.

64. The method of claim 53, further comprising considering the discrepancy between the first and second signal powers as the basis for determining the beamforming gain incremented in dependence on the first signal power being larger than the second signal power.

65. The method of claim 64, wherein the discrepancy is compensated based on a difference between a number of MIMO layers associated with the user feedback and the hypothesized number of MIMO layers.

66. The method of claim 64, wherein the discrepancy is compensated based on an inter-layer interference.

67. The method of claim 64, wherein the first and second signal powers are determined by scaling of respective channel estimates.

68. The method of claim 53, wherein the beamforming gain increment is determined per user.

69. The method of claim 53, wherein the user feedback comprises one or more of: channel quality information (CQI), precoding matrix index (PMI), and rank indicator (RI).

70. The method of claim 53, wherein the uplink channel estimate based beamforming is a reciprocity based beamforming.

71. The method of claim 53, wherein the uplink channel estimate based beamforming is determined by the radio access node based on one or more user transmission of at least one type of uplink signal, and wherein the at least one type of uplink signal comprises a sounding reference signal (SRS).

72. An apparatus for a radio access node configured for communication with a plurality of users by multiple-input multiple-output (MIMO) transmission, wherein the radio access node is configured to receive user feedback indicative of downlink channel estimates, and wherein the radio access node is configured to use uplink channel estimates for uplink channel estimate based beamforming of the MIMO transmission, the apparatus comprising controlling circuitry configured to cause:
determination of a beamforming gain increment achievable by use of the downlink channel estimates for beamforming of the MIMO transmission;
adjustment, based on the beamforming gain increment, of a signal-to-interference ratio (SIR) value and/or a signal-to-interference-and-noise ratio (SINR) value associated with the user feedback; and
downlink (DL) MIMO transmission to one or more user of the plurality of users based on the adjusted SIR value and/or SINR value.
